(19) United States
(12) Patent Application Publication
(10) Pub. No.: US 2017/0330131 A1
(43) Pub. Date: Nov. 16, 2017

(54) METHOD AND SYSTEM FOR REGISTERING HUMAN COGNITIVE ACTIVITY

(71) Applicant: NAMUH B.V., Wassenaar (NL)

(72) Inventor: Willem M. Vunderink, Wassenaar (NL)

(21) Appl. No.: 15/543,121

(22) PCT Filed: Jan. 13, 2015
(86) PCT No.: PCT/NL2015/050018

§ 371 Date: Jul. 12, 2017

(51) Int. Cl. G06Q 10/06; G06F 19/00

(52) U.S. Cl. CPC G06Q 10/063114; G06F 19/345

(57) ABSTRACT

It is aimed to provide a computer implemented method of registering human cognitive activity in a data capturing system. The system comprises a control module, a storage and a number of data sources registered in the control module and under human control. The method comprises: automatically and real time, without user interaction, registering by a control module real time data from various data sources; generating in real time windows a number of arrays; each array having a first weight attributed thereto indicating a real time cognitive activity value measured from said real time data and a second weight attributed thereto corresponding to said data source. For each real time window, using a predetermined first metric, a smallest distance is calculated between any of the weighted arrays to any one of other first arrays; so that a selected number of cases are identified wherein real time human cognitive activity is registered. Said selected numbers of cases correspond to a real time window wherein human cognitive activity is registered, in order of combined weights of said generated weighted arrays.

### FIELD OF INVENTION

The invention relates to a computer implemented method of registering human cognitive activity in a data capturing system that comprises a control module, a storage and a number of data sources registered in the control module and under control of human cognitive activity. The invention also relates to a data capturing system comprising said control module and storage and which is arranged for registering a number of data sources to be registered in the control module and under control of human cognitive activity. The invention further relates to a computer program product for putting into effect the method.

### DESCRIPTION OF THE PRIOR ART

Knowledge workers are persons who use intellectual rather than manual skills to make a living. What differentiates knowledge work from other work is that most knowledge work is about non-routine problem solving. Non-routine problem solving requires a combination of different intellectual capabilities such as information gathering and categorizing, comprehension of information, analyzing information using logical rules or mathematical reasoning, identifying known patterns or combining pieces of information to form new meaningful patterns, generating ideas around given information and topics, conceptual thinking, originality, creativeness, memorization, problem sensing, inductive reasoning, deductive reasoning and the ability to apply oral and written expression to improve the thinking process and communicate about it in interaction with others.

Examples of knowledge workers that perform such non-routine problem solving work are accountants, lawyers, consultants, (software) engineers, programmers, product developers, doctors, architects, scientists, researchers, inventors, financial or data analysts, bankers, brokers, managers, professors, teachers, etc.

Capturing data about intellectual activity, the output of such activity as well as time spent, has always been done using the knowledge worker's own assessment of his/her work. Knowledge work is an intellectual task that is performed under various circumstances and settings and since knowledge work aims to resolve non-routine problems, the working methods are often also non-routine and therefore difficult to measure. Intellectual tasks are fluent, and many times tasks are performed in parallel with other tasks. The human brain can handle various tasks and thinking processes at the same time even though some thinking processes are dominant over others.

A problem exists in correctly attributing time spent to specified cases that are preregistered in the data capturing system. Knowledge workers typically capture what they do either contemporaneously or by reconstructing what they did and how much time they spent on it after the fact (at the end of the day, week or month). Activities and time spent are easily lost, particularly when activities and time spent are reconstructed after the fact. Intellectual tasks also run on the background of the brain in order to resolve problems that are hard to comprehend or simply need mental digesting time and many knowledge workers have difficulty identifying these intellectual tasks for themselves. Currently available automated support tools such as time capture software do not resolve accuracy and integrity problems when capturing cognitive activity and time data. A known prior art device is described in US20090119062. The existing software is quite incapable of automating the process of capturing intellectual activities and time spent by knowledge workers in an accurate way.

### SUMMARY OF THE INVENTION

In one aspect, it is aimed to provide a computer implemented method of registering human cognitive activity in a data capturing system that comprises a control module, a storage and a number of data sources registered in the control module and under control of human cognitive activity. The method comprises:

preregistering in said storage a number of case profiles as first arrays identifying a set of case profile parameters that are specific to said data sources and corresponding to specified cases registered in the data capturing system;

preregistering in said storage a number of cognitive activity profiles as second arrays identifying a set of cognitive activity profile parameters that are specific to said data sources and corresponding to specified human activities registered in the data capturing system;

automatically and real time, without user interaction, registering by said control module real time data from said data sources;

generating in real time windows from said real time data from said variety of data sources, a number of third arrays; each third array having a first weight attributed thereto indicating a real time cognitive activity value measured from said real time data and a second weight attributed thereto corresponding to said data source;

calculating for each real time window, using a predetermined first metric, a smallest distance between any of the weighted third arrays to any one of the first arrays; so that a selected number of first arrays are identified wherein real time human cognitive activity is registered;

calculating, for said real time window, using a predetermined second metric, a smallest distance of any of the weighted third arrays to any one of the second arrays; so that a selected numbers of second arrays are identified corresponding to the registered human cognitive activity as separate items;

attributing said selected numbers of first arrays corresponding to specified cases to said real time window wherein human cognitive activity is registered, in order of combined weights of said generated third arrays.

An important aspect of the present method is the entire elimination of human assessment in the data capture and cognitive activity monitoring. Fully automated capturing of human cognitive activity yields a time tracking system with a high accuracy of assessments and thus provides an integrity that cannot be achieved by human effort.

### BRIEF DESCRIPTION OF THE DRAWINGS

The invention will be further elucidated in the figures:

FIG. 1 shows a schematic of a control system according to an embodiment of the invention;

FIG. 2 shows a schematic control method according to an embodiment of the invention;

FIG. 3 shows a first stage or level of data collection;

FIG. 4 shows next levels 2 and 3 according to an embodiment;

FIG. 5 shows an exemplary view of a time chart generated according to an embodiment.

### DETAILED DESCRIPTION

Unless otherwise defined, all terms (including technical and scientific terms) used herein have the same meaning as commonly understood by one of ordinary skill in the art to which this disclosure belongs as read in the context of the description and drawings. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some instances, detailed descriptions of well-known devices and methods may be omitted so as not to obscure the description of the present systems and methods. Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be further understood that the terms “comprises” and/or “comprising” specify the presence of stated features but do not preclude the presence or addition of one or more other features. All publications, patent applications, patents, and other references mentioned herein are incorporated by reference in their entirety. In case of conflict, the present specification, including definitions, will control.

The starting point of this novelty technique is the principle that although human thinking can itself not be measured, the output of such intellectual or cognitive knowledge work can be captured and measured. Written or oral output of a knowledge worker contains strong indicators of the intellectual activity and cognitive processes that precede such output. The presently disclosed method therefore does not just perform device handling measurement, but simultaneously analyses interaction between human beings and extracts meaning from that interaction in order to make cognitive activity assessments. Such assessments range from a simple assessment such as the subject of interaction (what is the output about and to what subject, project, client or patient does it relate) and timing (when was the activity performed and how long did it take) to a more complex assessment such as intellectual task and cognitive processes that must take place in the mind before being able to actually do something that can be captured on a device.

The term “circuit” is used in a conventional way to signify any structural hardware or software arrangement having a capability of executing program logic in order to provide a certain basic function. A skilled person is typically aware of how to operate or implement a circuit in the context of the description, with processor elements elucidated here below. The term “program logic” is used in a conventional way to signify the operating instructions, which may be embodied in hard- or software structures, that control a circuit to the designated functional behavior.

The term “signal line” is used in a conventional way to signify an information exchanged, which may be in the form of coded signals, in analog or digital fashion by any conventional communication device, where it is not excluded that other signal lines are available, but merely to signify that a certain connectivity is available. This may also indicate indirect connectivity, that is, a signal line may be provided by indirect signaling, for example, via another functional device.

The term “module” as in “storage module” or “receiver module” or “control module” is used to emphasize the modular character of these units, i.e. the functionality of the system is separated into independent, interchangeable units. The term “user interface” may comprise one or more hardware elements configured to perform operational acts in accordance with the present systems and methods, such as to provide control signals to the various other module components. The processor may be a dedicated processor for performing in accordance with the present system or may be a general-purpose processor wherein only one of many functions operate for performing in accordance with the present system. The processor may operate utilizing a program portion, multiple program segments, or may be a hardware device utilizing a dedicated or multi-purpose integrated circuit. Any type of processor may be used such as a dedicated or shared one. The processor may include micro-controllers, central processing units (CPUs), digital signal processors (DSPs), ASICs, or any other processor(s) or controller(s) such as digital optical devices, or analog electrical circuits that perform the same functions, and employ electronic techniques and architecture. The controller or processor may further comprise a memory that may be part of or operationally coupled to the controller. The memory may be any suitable type of memory where data is stored. Any medium known or developed that can store and/or transmit information suitable for use with the present systems and methods may be used as a memory. The memory may also store user preferences and/or application data accessible by the controller for configuring it to perform operational acts in accordance with the present systems and methods.

While example embodiments are shown for systems and methods, also alternative ways may be envisaged by those skilled in the art having the benefit of the present disclosure for achieving a similar function and result. E.g. some components may be combined or split up into one or more alternative components. Finally, these embodiments are intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the scope of the present systems and methods as set forth in the claims that follow. The specification and drawings are accordingly to be regarded in an illustrative manner and are not intended to limit the scope of the appended claims.

In the exemplary embodiments a working principles is illustrated by depicting the various stages of data collection and analysis as three different stages. The end result of these stages is mapped in a datagram in which activities are plotted on a timeline with various measurements plotted individually in coding and across different lines to capture various types of data, relevance of data, interconnectivity between data and auxiliary versus primary data. The datagram is used to continuously improve assessments during the day as well as by comparing datagrams of different days with e.g. previous/older datagrams (lookback function) and adjusting afterwards both new and previous datagrams when more data is found that proves with higher probability certain assessments. In particular a so called Implict Time & Activity assessments (ITA data) is used to fill in gaps in the timeline that devices cannot accurately define. As ITA is subject to probability analysis with large quantities of data, its probability keeps improving. In practice, knowledge workers can work with around 80% or higher probability as the human assessment accuracy is often lower than that. The method therefore does not necessarily need to reach 100% accuracy on all activity and time assessments, although a large part of information is assessed with 100% accuracy.

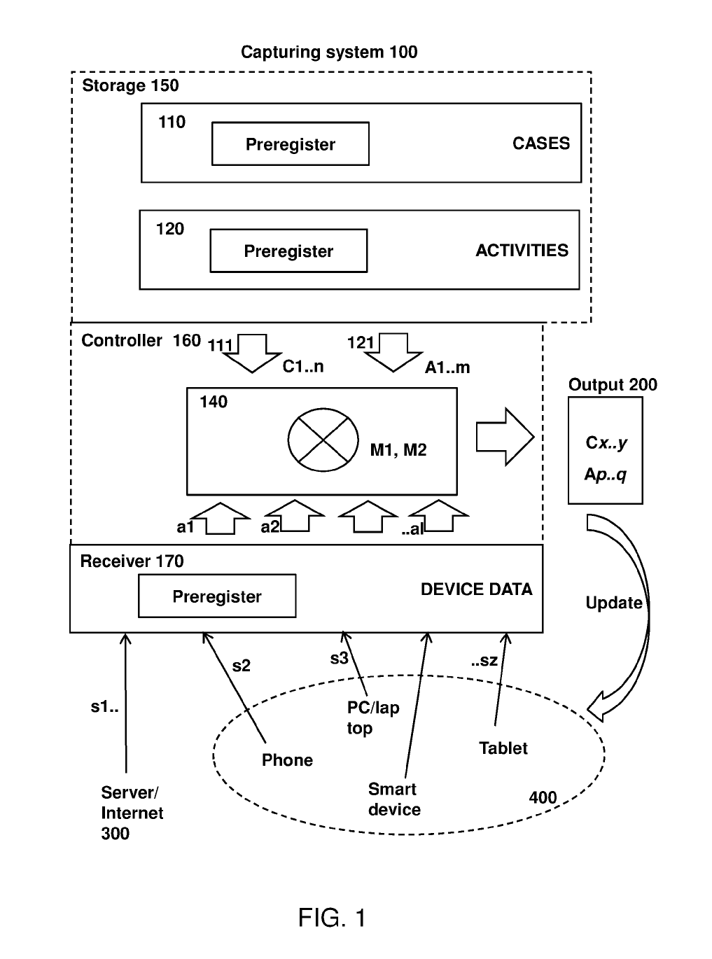

Now turning to FIG. 1, there is disclosed a data capturing system 100 comprising a control module 160, a storage 150 and arranged via depicted signal lines, for registering a number of data sources 300, 400 to be registered in the control module and under human control, i.e. operated by a human whose cognitive activity is being assessed. Exemplary data sources s1 . . . z (z some natural number) are a phone, laptop, tablet computer or other smart device that is used by a professional in performing his activity. Other data sources are server or Internet data retrieved by a search engine that can be carried out to identify various real time activities of the specified users registered by the data capturing system. For example a custom hook into a telephone system may allow event monitoring to be employed in detecting when a telephone call is made and when it ends. In addition, by customisation of header files caller ID and telephone numbers can be retrieved. In another example, bluetooth frameworks may be used to collect information on devices surrounding the users phone at all times. Also, by a location framework users position and their movements can be tracked, and, further, by comparing locations and time taken to travel between them will allow for a measurement of speed.

A storage module 110 comprises logic for preregistering in said storage 150 a number of case profiles 111. For example, such case profiles concerns a parametrizable data, for instance, enumerating multiplets of keywords that are identified as case specific, or other feature codings specific to a case, such as persons associated to a case, regions or specified products. Accordingly first arrays (C1 . . . n) are stored (rt some predetermined natural number) that each identify a set of case profile parameters that are specific to said data sources and corresponding to specified cases (1 . . . rt) registered in the data capturing system. Furthermore a storage module 120 comprises logic for preregistering in said storage 150 a number of cognitive activity profiles 121. Activity profiles 121 are formed by parametrizable sets of keywords specific for certain activities. For example, by data analysis, specifically, keyword patterns and frequencies on the device data, sets of information are created indicative of an intellect level required for the person performs a certain task (see further embodiments: Intellect Level Indicators, abbreviated as ILI) and a dominance level of tasks, indicative of how busy a person is with carrying out the specific task, when a number of tasks are carried out simultaneously (see further embodiments here below: Dominant Activity Qualification, abbreviated as DAQ).

Communication of such collected data may be done by transmitting a digest of metadata to a server, e.g. via an encrypted RESTful HTTP interface. Such digests may also be stored and synchronized with the central service in the event of a loss of cellular or WiFi connectivity, once connection has been re-established. The data can be authenticated using known authentication procedures. Also, inactivity of certain devices may be made available on the central server.

Correspondingly, second arrays A1 . . . m (in some predetermined natural number) are prestored that identify a set of cognitive activity profile parameters that are specific to said data sources and corresponding to specified human activities (1 . . . m) registered in the data capturing system.

Further, in the capturing system, a receiver module 170 comprises logic for automatically and real time, without user interaction, receiving by said control module real time data from said data sources. The module 170 further comprising logic for generating in real time windows from said real time data from said variety of data sources s1 . . . z, a number of third arrays; each third array having a first weight (a1 . . . n) attributed thereto indicating a real time cognitive activity value measured from said real time data and a second weight s1 . . . z attributed thereto corresponding to said data source. The weights can be used to set up a predetermined type of multipoint analysis of data obtained from various sources. E.g. emails and electronic agenda's may be scanned using a number of APIs, to infer certain activities.

Decision logic may subsequently determine a weight that is attributed to the third arrays and to perform integrity check in case of conflicting data. For example, by verifying location data of the portable devices, it may be decided what a dominant cognitive activity is of a person in a specified real time window, which may override data analysis performed from raw data analysis. In this way available datapoints may be scanned and linked to client based activities and to create inferred links between activities using a relational analysis method to link reported datapoints to cases, billable activities and/or clients.

Controller 160 comprises a control module 140 comprising logic for calculating for each real time window, using a predetermined metric M1 (first metric), a smallest distance between any of the weighted third arrays (a1 . . . an) to any one of the first arrays C1 . . . n. Such a metric may for example be formed by an identity match of certain array patterns of keywords, or by a ranking order of keywords and frequencies, that are predefined in the capturing system in order to identify a distance measure between a third array and any of the first arrays. Such a distance measure is a per se known way of characterizing a weighted overlap or match between two data sets.

In this way a selected number of first arrays Cx . . . Cy are identified wherein real time human cognitive activity is registered in a specified time window during an cognitive activity capturing or monitoring period. In addition to the prementioned first metric, the module 140 further comprising logic for calculating, for said real time window, using a predetermined second metric M2, a smallest distance of any of the weighted third arrays to any one of the second arrays. In a corresponding fashion as with the first matching operation, by weighted combination of pattern matching and/or pattern frequency analysis a selected numbers of said second arrays A1 . . . m are identified. corresponding to the registered human cognitive activity as separate items Ap . . . Aq. Thus, a number of specific activities (p . . . q) are identified that are listed in a certain numbered cognitive activity list. In another example, selected numbers of second arrays Ap . . . Aq can be attributed that sets up the capturing system in a corresponding mode, e.g. a time track mode, billing mode or communication mode to communicate that a certain cognitive activity is carried out. In this way the capturing system 100 is provided with cognitive activity monitor specific Intellectual Task Taxonomy (ITT) that can be universally applicable on knowledge workers regardless of profession and therewith enabling the activity monitor technology to be used in virtually any knowledge work sector. IAD information is extracted from documents and records containing written or oral (requiring speech recognition and conversion into text records) information produced by the knowledge worker, which corresponds to specified activities to said real time window wherein human cognitive activity is registered, in order of combined weights (a1 . . . l) of said generated third arrays.

In addition to the layout of capturing system 100 as here above described output module in correspondence thereto 200 comprises logic for attributing said selected numbers of first arrays corresponding to specified cases to said real time window wherein human cognitive activity is registered, in order of combined weights of said generated third arrays (a1 . . . l). For example, the output module may be a display generating a number of specified cases that are activated in the system during the real time period, so that human interaction is not specifically needed to set up the system for monitoring, reporting and billing purposes. Alternatively or additionally thereto, the output module may be structured to output a time chart with in each real time window listing specified cases corresponding to the first identified arrays Cx . . . y and for each specified case having specified real time human activities corresponding to said second arrays Ap . . . q. In a particular embodiment, a server application provide a secure HTTP interface for receiving data from the data capturing system 100, e.g. as an interface for reporting data or to provide an easy to use Web frontend for users. For example, the interface may display a time chart may as single pair of listed cases in each time window, ranked to a measured real time cognitive activity value, for example, a first dominant cognitive activity and another cognitive activity that may be regarded as background cognitive activity.

Importantly a selected number of data sources registered in said modules may be updated by controller 160 under control of said generated third arrays, to preset those devices according to a measured intellectual activity. The advantage of such update control is that the device can be optimized to carry out certain task associated with the intellectual activity of the worker, without having to manually instruct those devices.

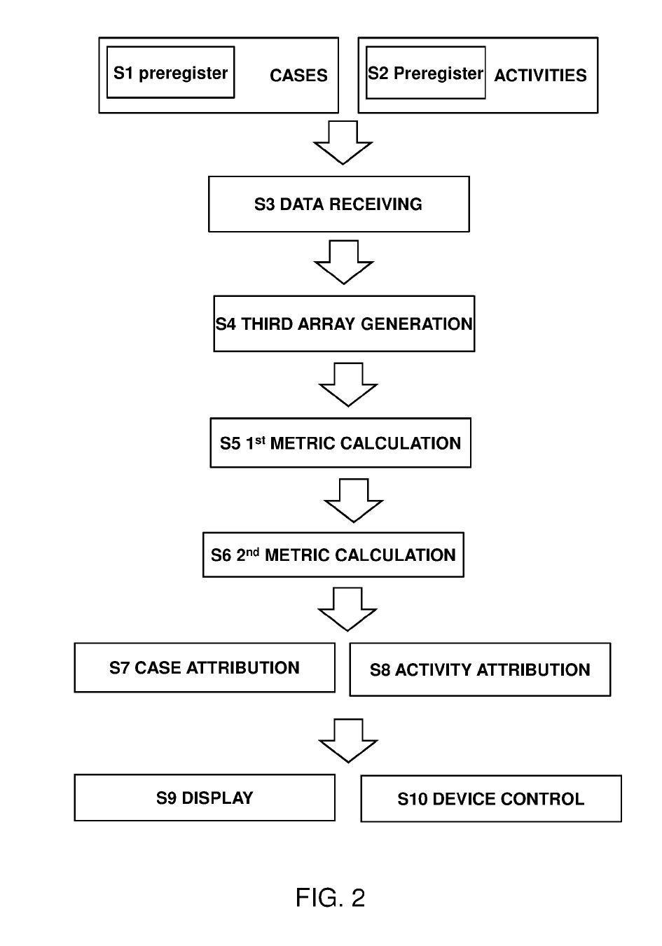

FIG. 2 shows an exemplary number of steps that embody the present invention, in particular, as carried out by the system described here above, and which may be embodied in a computer program product having computer program logic arranged for executing on a data capturing system that comprises a control module, a storage and a number of data sources registered in the control module and arranged to put into effect the disclosed method. In a first step S1 a number of case profiles are pre-registered as first arrays. Correspondingly, said first arrays identify a set of case profile parameters that are specific to said data sources and corresponding to specified cases registered in the data capturing system. In a second step (S2) a number of cognitive activity profiles are pre-registered as second arrays. Thereby a set of cognitive activity profile parameters are identified that are specific to said data sources and corresponding to specified human activities registered in the data capturing system. When the data capturing system is active, without any user interaction, real time data is automatically and real time received in step S3 by said control module from said data sources. Subsequently, in step S4 a number of third arrays are generated during said real time windows from said real time data from said variety of data sources. Each third array has a first weight attributed thereto indicating a real time cognitive activity value measured from said real time data and a second weight attributed thereto corresponding to said data source, as explained here above with reference to FIG. 1. In a further step S5, for each real time window, using a predetermined first metric, a smallest distance is calculated between any of the weighted third arrays to any one of the first arrays; so that a selected number of first arrays are identified wherein real time human cognitive activity is registered. Then, in a next step S6 using a predetermined second metric, a smallest distance of any of the weighted third arrays are calculated to any one of the second arrays; so that a selected numbers of second arrays are identified corresponding to the registered human cognitive activity as separate items. Next, in step S7 said selected numbers of first arrays Cx . . . y are attributed to specified cases, in certain order controlled by combined weights (a1 . . . sn) corresponding to the multipoint analysis of a number of different sources.

Optional steps S8 signify attributing said selected numbers of second arrays Ap . . . Aq corresponding to specified activities to said real time window wherein human cognitive activity is registered, in order of combined weights (a1 . . . dn) of said generated third arrays. Accordingly, using a predefined taxonomy information is identified that can identify certain intellectual task types, but additionally may also identify an emotional status of the person performing the intellectual task. Further optional steps may displaying S9 the output in a suitable fashion, e.g. to use it in a further technical process e.g. for controlling S10 the data sources or for displaying certain activities in an ordered fashion e.g. in a time chart, as further exemplified below.

### Further Embodiments

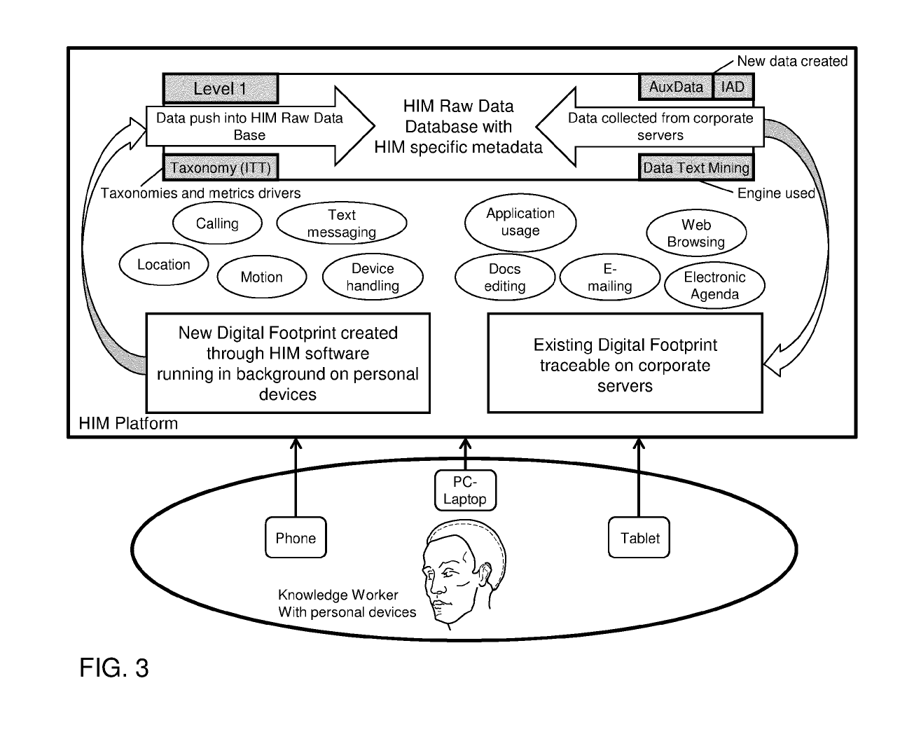

FIG. 3 shows as a further embodiment, further expanding on the previous embodiments, a first stage or level of data collection. In this stage, metadata or Raw Data is stored, that is to be processed into subsequent stages 2 and 3. The picture should be read bottom-up, starting with personal device that are registered in the name of a human being. Each knowledge worker thus has its own digital footprint and therefore its own digital activity capturing process. As shown in FIG. 3, various sorts of data are collected and created. Personal devices capture information and push it into a data processing platform that also simultaneously collects further personal footprint data on corporate servers, internet etc. The metadata that is created in Level 1 can be categorized in two major categories that are relevant in Level 3 but first created in Level 1: Auxiliary data (AuxData) and Intellectual Activity Data (IAD). Auxiliary data is used to enhance accuracy in assessing activities and contains information about location, motion or proximity to other people. Most AuxData is generated by and pushed into the cognitive activity monitor database through small activity monitor-applications (scripts) running in the background of personal devices used by a knowledge worker personally (smartphone, smartwatch, tablet, laptop/pc).

IAD is generated with text mining technology that makes use of activity monitor specific Intellectual Task Taxonomy (ITT) that is universally applicable on any knowledge worker regardless of profession and therewith enabling the cognitive activity monitor technology to be used in virtually any knowledge work sector. IAD information is extracted from documents and records containing written or oral (requiring speech recognition and conversion into text records) information produced by the knowledge worker. IAD information is used to enrich the metadata so that the cognitive activity monitor can qualify intellectual activity.

On the basis of Raw Data, the cognitive activity monitor analyses meaning of text in various records or documents and adds indicators and metadata to capture data on time/duration of activities, type of cognitive activity (listening, reading, writing, comprehending, asking questions, answering, analysing, producing ideas, inventing solutions, deploying standard procedures, developing new procedures, apply rules, apply number facility, mathematical reasoning, meeting with others, gathering information, etc.), related subjects marked by activity monitor as known or related based on high probability (projects, clients or patients) and related persons.

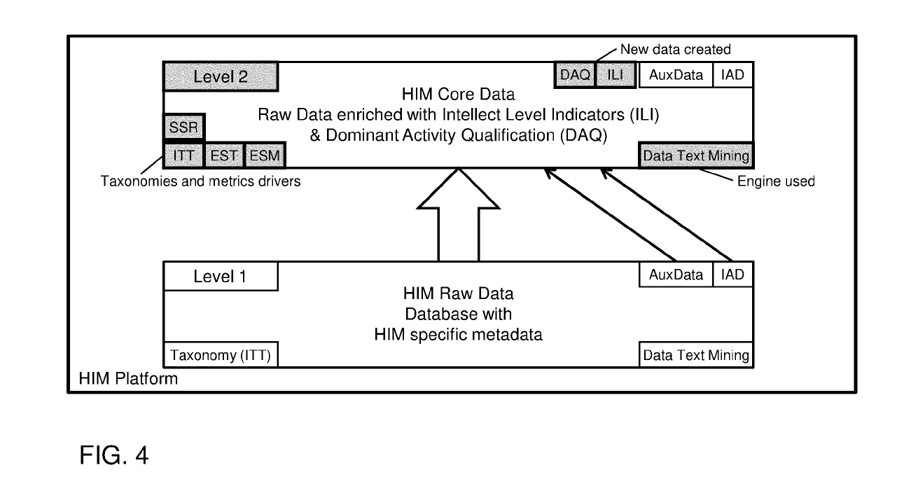

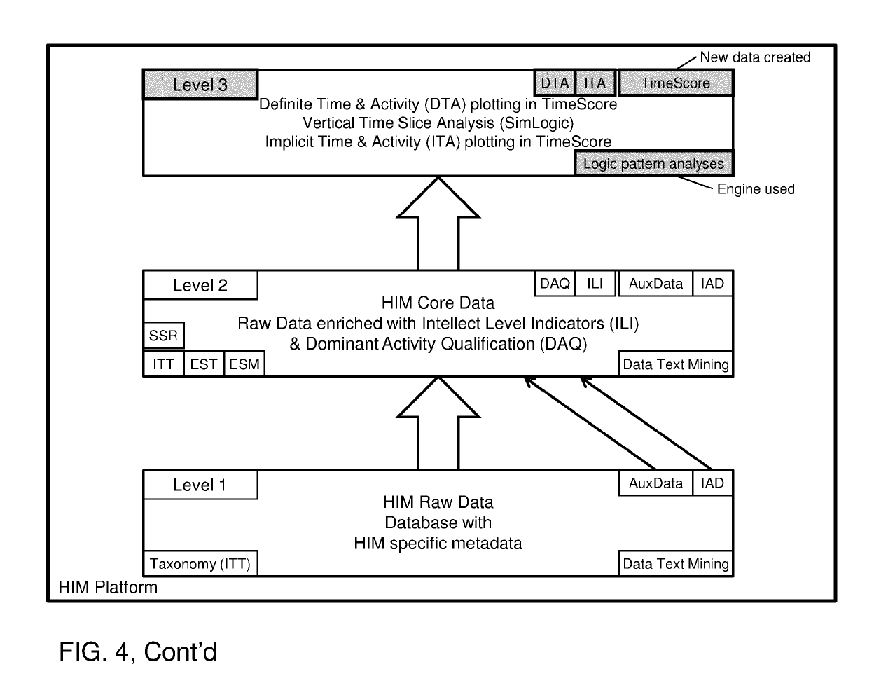

In FIG. 4, next levels 2 and 3 are shown, as follows. In Level 2 Raw Data is processed from Level 1 into further enriched data by applying another layer of logical analysis on the data. Two sets of information are created, being (i) the level of intellect required to perform a task (Intellect Level Indicators, abbreviated as ILI) and (ii) the dominance level of tasks (Dominant Activity Qualification, abbreviated as DAQ). Dominance levels indicate whether tasks are likely to demand the knowledge worker's cognitive abilities predominantly and therefore running through longer parts of the day, even when other (recessive) intellectual tasks are being performed. Dominance information is used in Level 3 of the activity monitor information processing (see hereafter). Dominance information is identified using text mining technology combined with cognitive activity monitor specific logical analysis driven by Intellect Task Taxonomy (ITT), Emotional Status Taxonomy (EST), Emotional Status Metrics (ESM) and Same Subject Ratios (SSR).

In Level 3, selected data is used from Levels 1 and 2 to define actually measured activities and when they occurred, also called Definite Time & Activity (DTA) information, plotted in a time chart. Such DTA is information tells 100% accurately what cognitive activity was performed and when it was performed. DTA information for example is data from devices that tells with full accuracy that an email was opened, read or written, and exactly how long after opening it was closed so it contains information on time of cognitive activity and the contents (including subject and Intellectual Level Information) and how long the activity took. DTA can also be captured measuring various other applications on personal devices (wordprocessing, webbrowsing, databases, calculation tools, analytical software, etc.).

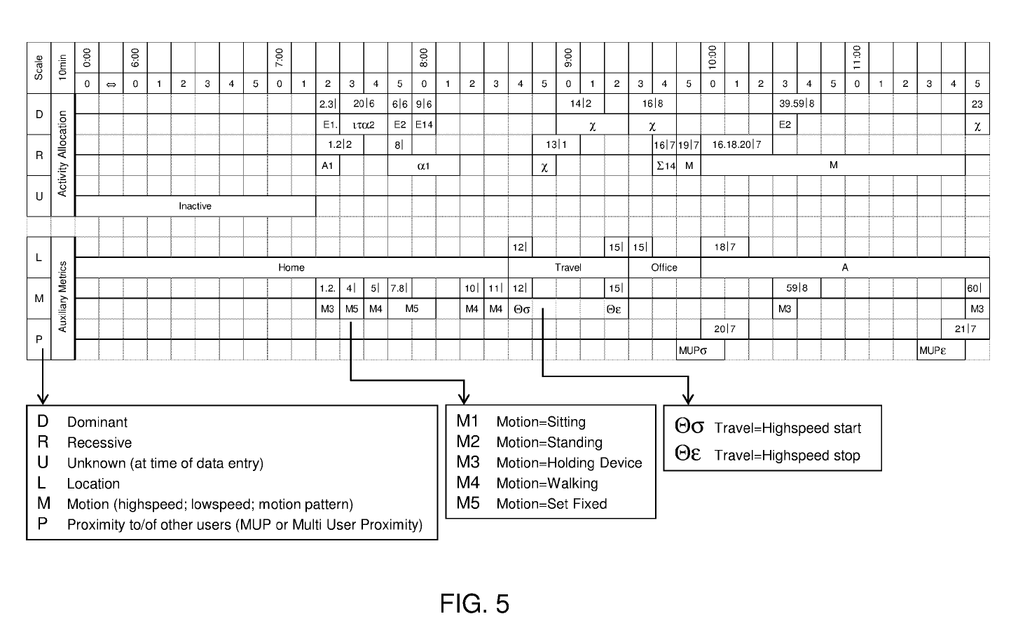

In FIG. 5, an example is shown of such a time chart which resembles a notation system similar to music notation. A music notation system is any system that is used to visually represent aurally perceived music through the use of written symbols. A musician can play the music when he/she can read the written symbols. The logic applied to the data plotted in the TimeScore notation system is the core data analysis of the cognitive activity monitor and is basically the automated version of human logic. But the human mind cannot instantly recognize the logic applied on complex datasets, unless the logic between various data points is visualized in a way that the human mind can easily comprehend. As for music, it contains lots of information and data points that not only run in sequence (across a timeline where time is measured in time signatures or beats) but many data points and information is to be comprehended in parallel, so at the same time (time signatures, for various instruments up to ten notes at the same time, note relationships, pitch range, duration, breaks, dynamics, volume, intensity, articulation, ornaments, instrument specifics, etc.) which is not only too much information when writing it down in normal language but language also arranges information in sequence. The cognitive activity monitor captures data points about a single instant, similar to music that for each instant has multiple data points to process. Since music proves that the trained human mind of a musician can instantly recognize a myriad of symbols and process such information at the same time, the cognitive activity monitor's TimeScore notation can rely on that same human ability of instantly recognizing the meaning of various datapoints that are presented visually and using easily recognizable symbols. The cognitive activity monitor's TimeScore does exactly that, and allows the human eye to instantly recognize the cognitive activity plotted for a certain knowledge worker and recognize the logic between data points for each instant in time. The importance of this is in the necessity for any knowledge worker or organization to monitor the accuracy of the cognitive activity monitor and make corrections if needed. In order to do that, one must know where to make corrections and where not.

The cognitive activity monitor adds more detailed information to the initially recognizable data points so that more information can be found on activities that require further analysis.

The TimeScore consists of 2 systems. The top system captures the primary data on a person's activities, divided into Dominance (D), Recessive (R) and Unknown (U) activities. The bottom system captures auxiliary data on Location (L), Motion (M) and Proximity (P) to other people.

Dominant activities are plotted on the first line (marked D), whereas recessive activities are plotted on the second line (marked R). In case not all relevant (e.g. subject) information is missing, activities are initially plotted on the line Unknown until findings are improved.

Dominance information is used to allow the cognitive activity monitor to plot activities in parallel, as one cognitive activity does not necessarily exclude another from being processed at the same time (typical for many intellectual abilities), particularly when one cognitive activity is dominant and the other is recessive.

By making a distinction between dominant and recessive information, the cognitive activity monitor can furthermore make a probability analysis of implicit activities, i.e. activities that were not actually captured with hard data. The cognitive activity monitor can make probability analysis about when such implicit activities were performed (Implicit Time & Activity, or ITA) and what the intellectual activity was. This is where dominance information is essential, as the activity monitor will search for logical patterns to find interconnected information relating to high dominance activities as these activities have a high probability of absorbing cognitive abilities in between measured dominant activities (DTA) or in parallel with recessive activities. Unless excluded by logical rules, the cognitive activity monitor can make assessments of implied activities and when they occurred (Implicit Time & Activity, or ITA).

Other ITA assessments can be made when various data points indicate that certain activities must have happened at a certain point in time. That is why the cognitive activity monitor uses multi layered plotter technique to assure that correlations between various data points can be made, both ‘horizontally’ (comparing data entries from different points in time) as well as ‘vertically’ (comparing data entries that occur at the same time).

A specific form of vertical analysis that the cognitive activity monitor deploys is Vertical Time Slice Analysis where the activity monitor once all data is plotted in TimeScore for each ‘slice of time’, slicing vertically through all layers, compares data plotted on any of the 6 lines that occurs at the same vertical ‘timeslice’. The VTSA assesses for each point in time whether all data entries that are plotted at the same point in time (hence a vertical slice methodology) are logically connected and substantive for the DTA or ITA plotted for that specific point in time. The cognitive activity monitor uses the VTSA to validate whether activities are plotted correctly and logically, considering all underlying data for that point in time. The human eye can do the same exercise quite easily and validate whether assessments of activities are logical or not.

The accuracy of cognitive activity assessments depends on the depth of measurements, hence cognitive activity monitor creates different layers of information. Data in each layer can be compared and combined with data in other layers in order to make an accurate assessment of cognitive activity. Below is series of pictures depicting a more detailed description of TimeScore data, which also illustrate the various layers of information.

1. A computer implemented method of registering human cognitive activity in a data capturing system that comprises a control module, a storage and a set of data sources registered in the control module and under human control; said method comprising:
preregistering in said storage a set of case profiles as a first set of arrays identifying a set of case profile parameters that are specific to said set of data sources and corresponding to specified ones of a set of cases registered in the data capturing system;
preregistering in said storage a set of cognitive activity profiles as a second set of arrays identifying a set of cognitive activity profile parameters that are specific to said set of data sources and corresponding to specified ones of a set of human cognitive activities registered in the data capturing system;
receiving, by said control module, automatically and in real time, without user interaction, real time data from said data sources;
generating from said real time data from said variety of data sources, a third set of arrays in real time windows, each one of the third set of arrays having:
a first weight attributed thereto indicating a real time cognitive activity value measured from said real time data, and
a second weight attributed thereto corresponding to said data source;
calculating for each real time window, using a predetermined first metric, a smallest distance between any of the weighted ones of the third set of arrays to any one of the first set of arrays, so that a selected number of the first set of arrays are identified wherein real time human cognitive activity is registered;
calculating for said real time window, using a predetermined second metric, a smallest distance of any of the weighted ones of the third set of arrays to any one of the second set of arrays, so that selected ones of the second set of arrays are identified as corresponding to the registered human cognitive activity as separate items; and
attributing said selected ones of the first set of arrays corresponding to specified ones of the set of cases to said real time window wherein human cognitive activity is registered, in order of combined weights of said third set of arrays.

2. The computer implemented method according to claim 1, further comprising attributing said selected numbers of the second set of arrays corresponding to specified activities to said real time window wherein human cognitive activity is registered, in order of combined weights of said third set of arrays.

3. The computer implemented method according to claim 1, further comprising outputting said real time windows in a time chart within each real time window having specified cases corresponding to said first set of arrays and for each specified case having specified real time human activities corresponding to said second set of arrays.

4. The computer implemented method according to claim 3, wherein said time chart displays a pair of cases in each time window, ranked to a measured real time cognitive activity value.

5. The computer implemented method according to claim 1, wherein a selected number of data sources registered in said modules are updated under control of said third set of arrays.

6. A data capturing system comprising a control module and a storage, wherein the data capturing system is arranged for registering a set of data sources to be registered in the control module and under control of human cognitive activity; said storage containing computer-executable instructions that, when executed by the processor, cause the data capturing system to carry out a method comprising:
preregistering in said storage a set of case profiles corresponding to specified cases registered in the data capturing system;
preregistering in said storage a set of cognitive activity profiles corresponding to specified human cognitive activities registered in the data capturing system;
receiving, by said control module, automatically and in real time, without user interaction, real time data from said data sources in a multipoint pattern of timed data sequences;
matching said multipoint pattern to said set of case profiles and said set of cognitive activity profiles, using a predefined taxonomy corresponding to a set of intellectual task types and emotional status of a person performing the intellectual task.

7. A data capturing system comprising a control module and a storage, wherein the data capturing system is arranged for registering a set of data sources to be registered in the control module and under control of human cognitive activity; said storage containing computer-executable instructions that, when executed by the processor, cause the data capturing system to carry out a method comprising:
preregistering in said storage a set of case profiles as a first set of arrays identifying a set of case profile parameters that are specific to said set of data sources and corresponding to specified ones of a set of cases registered in the data capturing system;
preregistering in said storage a set of cognitive activity profiles as a second set of arrays identifying a set of cognitive activity profile parameters that are specific to said set of data sources and corresponding to specified ones of a set of human activities registered in the data capturing system;
receiving, by said control module, automatically and in real time, without user interaction, real time data from said data sources;
generating in real time windows from said real time data from said variety of data sources, a of third set of arrays, wherein each one of the third set of arrays has:
a first weight attributed thereto indicating a real time cognitive activity value measured from said real time data, and
a second weight attributed thereto corresponding to said data source;
calculating for each real time window, using a predetermined first metric, a smallest distance between any of the weighted ones of the third set of arrays to any one of the first set of arrays, so that a selected number of the first set of arrays are identified wherein real time human cognitive activity is registered;
calculating, for said real time window, using a predetermined second metric, a smallest distance of any of the weighted ones of the third set of arrays to any one of the second set of arrays, so that a selected numbers of said second arrays are identified corresponding to the registered human cognitive activity as separate items;
attributing said selected ones of the first set of arrays corresponding to specified cases to said real time window wherein human cognitive activity is registered, in order of combined weights of said generated third arrays.

8. A data capturing system according to claim 6, the method further comprising updating selected ones of the data sources registered in said receiver module under control of said third set of arrays.

9. A data capturing system according to claim 7, wherein said updating comprises updating a selected source corresponding to a selected case profile or cognitive activity profile.

10. A computer program product having computer program logic arranged for executing on a data capturing system that comprises a control module, a storage and a number of data sources registered in the control module and arranged to put into effect the method of claim 1.
